(19) United States
(12) Patent Application Publication
(10) Pub. No.: US 2001/0051962 A1
(43) Pub. Date: Dec. 13, 2001

(54) Presentation customization

(76) Inventor: Robert Plotkin, Somerville, MA (US)

Correspondence Address: Robert Plotkin, 18 Westminster Street, Somerville, MA, 02144, US

(21) Appl. No.: 09/877,523

(22) Filed: Jun. 8, 2001

Related U.S. Application Data
(60) Provisional application No. 60/210,196, filed on Jun. 8, 2000.

(51) Int. Cl. G06F 15/00

(52) U.S. Cl. 707/522; 707/507; 707/511

(57) ABSTRACT

In a system including a document collection, document templates specifying fixed information in the document collection, document data specifying variable information in the document collection, an information integration specification specifying a process for integrating the fixed information and the variable information, and a document generator to generate the document collection based on the document templates, the document data, and the information integration specification, a computer-implemented method is provided to receive input indicating modifications to fixed information in at least one of the documents in the document collection, and to modify the document templates to specify the modified fixed information in response to the input. Fixed information in the at least one of the documents may be modified to reflect the modifications indicated by the input. A second document collection may be generated that includes the variable information and the modified fixed information.

### CROSS REFERENCE TO RELATED APPLICATIONS

This application claims priority from U.S. Provisional Patent Application Serial No. 60/210,196, filed on Jun. 8, 2000, entitled “Presentation Customization,” which is hereby incorporated by reference in its entirety.

### BACKGROUND

1. Field of the Invention

The present invention relates to the customization of computer-generated presentations and, more particularly, to the customization of computer-generated documents generated using document templates.

2. Related Art

Many document creation tasks involve the generation of a large number of documents, each of which contains some fixed information that is common to all of the documents and some variable information that differs from document to document. For example, letters sent to consumers in a mass mailing typically contain a common body and differ only in the name and address of the recipient. Manually copying the body into each letter is a tedious and time-consuming task. Document assembly systems have been developed to simplify the task of generating such documents by eliminating the need to manually copy the fixed information into each document and by automating the process of merging the fixed information with the variable information.

Referring to FIG. 1, in a conventional document assembly system 100, a document generator 106 integrates a document template 102 with document data 104 to generate a document collection 108. The document collection 108 includes documents 108a-n, where n is the number of documents. The document template 102 contains fixed information that is common to all of the documents 108a-n in the document collection 108. Document template 102 also typically specifies how variable information (contained in the document data 104) that is specific to each of the documents 108a-n is to be integrated with the fixed information in the document template 102 to generate the document collection 108. Document data 100 includes data records 104a-n, each of which typically specifies variable information for a particular one of the documents 108a-n in the document collection 108. For example, the data record 104a may specify variable information for document 108a. Each of the documents 108a-n generated by the document assembly system 100 therefore contains fixed information specified by the document template 102 as well as variable information specified by the corresponding one of the data records 104a-n.

One example of the document assembly system 100 is a conventional mail merge feature provided by many word processors. Such a mail merge feature allows users to simplify tasks such as generating large numbers of form letters which contain the same body and differ only in the name and address of the recipient. In the context of a mail merge, a “form document” plays the role of the document template 102, a “data document” plays the role of the document data, data records within the data document play the role of the data records 104a-n, a mail merger plays the role of the document generator 106, and merged documents play the role of the documents 108a-n. The form document contains fixed information, such as formatted text and graphics, representing the body of the letter that is to be included in each of the merged documents. Each of the data records contains variable information, such as the name and address of a particular recipient, to be included in the corresponding one of the merged documents. Tags at particular locations in the form document specify which information (e.g., the recipient's name or address) from the data records 104a-n is to be included at corresponding locations in the merged documents. Each of the merged documents generated by the mail merger contains the fixed information specified by the form document (e.g., the body of the form letter) merged with the variable information specified by the corresponding data document (e.g., recipient name and address).

Generating the document collection 108 using the document assembly system 100 may require the user to perform less work than would be required if the user generated the document collection 108 manually. For example, when using the document assembly system 100 the user may only need to manually generate the fixed information contained in the document template 102 once, because the document generator 106 automatically copies the fixed information contained in the document template 102 into each of the documents 108a-n. This eliminates the need for the user to manually generate the fixed information in each of the documents 108a-n.

In some circumstances it may be desirable to modify or replace documents in the document collection 108 after they have been generated by the document generator 106. For example, some of the fixed information contained in the document template 102 may not be appropriate for a particular one of the documents 108a-n. In such a case it may be desirable to modify the fixed information in the particular document after it has been generated by the document generator 106. Some document assembly systems (e.g., word processors with mail merge features) allow the user to manually modify the fixed information in the documents 108a-n, the variable information in the documents 108a-n, or both, after the documents 108a-n have been generated by the document generator 106. Such manual modification can be tedious and time-consuming.

Another circumstance in which it may be desirable to modify or replace the documents 108a-n is that in which the fixed information in the document template 102 has been modified after the generation of the documents 108a-n by the document generator 106. In this circumstance the user may cause the document generator 106 to apply the modified document template to the document data 104 to produce documents containing the modified fixed information from the document template and the document data 104. Yet another circumstance in which it may be desirable to modify or replace the documents 108a-n is that in which the document data 104 have been modified. In this circumstance the user may cause the document generator 106 to apply the document template 102 to the modified document data to produce documents containing the fixed information contained in the document template 102 and the modified document data.

Re-generating the documents 108a-n using the document generator 106, however, will typically result in the loss of manual modifications previously made by the user to the documents 108a-n. For example, if the user generates the documents 108a-n using the document generator 106, makes manual modifications to (fixed or variable) information in the documents 108a-n, and then re-generates the documents 108a-n using the document generator 106, the re-generated documents will no longer contain the manual modifications previously made by the user.

In summary, modification of the documents 108a-n generated by the document assembly system 100 can be tedious and time-consuming. Furthermore, it is typically not possible to manually modify the documents 108a-n generated by the document generator 106, and then to use the document generator 106 to generate a new version of the documents 108a-n (incorporating, for example, changes to the document template 102 or to the document data 104) which retains the previously-made manual document modifications. What is needed, therefore, is a system for facilitating the customization of documents generated by document assembly systems.

### SUMMARY

In one aspect, the present invention enables a user to modify the fixed information specified by a document template in a document assembly system by modifying a document generated by the document assembly system. For example, the user may modify fixed information in a document generated from document templates, and thereby cause the document templates to specify the modified fixed information. Subsequent documents generated from the document templates will include the modified information. Modifications to a document template may be stored in the same document template or in another document template. Priorities may be assigned to document templates and to modifications to document templates, and such priorities may enable certain information specified by the document templates to override other information specified by the document templates. These and other features of various embodiments of the present invention advantageously provide the user of the document assembly system with a finer degree of control over document template customization and simplify the process of document assembly.

In another aspect, a computer-implemented method is provided in a system including a document collection, document templates specifying fixed information in the document collection, document data specifying variable information in the document collection, an information integration specification specifying a process for integrating the fixed information and the variable information, and a document generator to generate the document collection based on the document templates, the document data, and the information integration specification. The method receives input indicating modifications to fixed information in at least one of the documents in the document collection, and modifies the document templates to specify the modified fixed information in response to the input. Fixed information in the at least one of the documents may be modified to reflect the modifications indicated by the input. A second document collection may be generated that includes the variable information and the modified fixed information.

Other features and advantages of the invention will become apparent from the following description and from the claims.

### BRIEF DESCRIPTION OF THE DRAWINGS

FIG. 1 is a block diagram of a conventional document assembly system.

FIG. 2 is a block diagram of a document assembly system according to one embodiment of the present invention.

FIG. 3A is a diagram of a record definition according to one embodiment of the present invention.

FIG. 3B is a diagram of a data record according to one embodiment of the present invention.

FIG. 4 is a diagram of a combination of a data structure for representing an information integration specification according to one embodiment of the present invention.

FIG. 5 is a flowchart of a method for generating a document collection according to one embodiment of the present invention.

FIG. 6 is a flowchart of a method for generating fixed information according to one embodiment of the present invention.

FIG. 7 is a flowchart of a method for generating fixed information according to another embodiment of the present invention.

FIG. 8 is a flowchart of a method for generating fixed information specified by the document templates according to one embodiment of the present invention.

FIG. 9 is a block diagram of a document editing system according to one embodiment of the present invention.

FIGS. 10A-C are flowcharts of methods for modifying document templates in response to user input according to various embodiments of the present invention.

FIGS. 11A-C are flowcharts of methods for modifying document templates in response to user input according to various embodiments of the present invention.

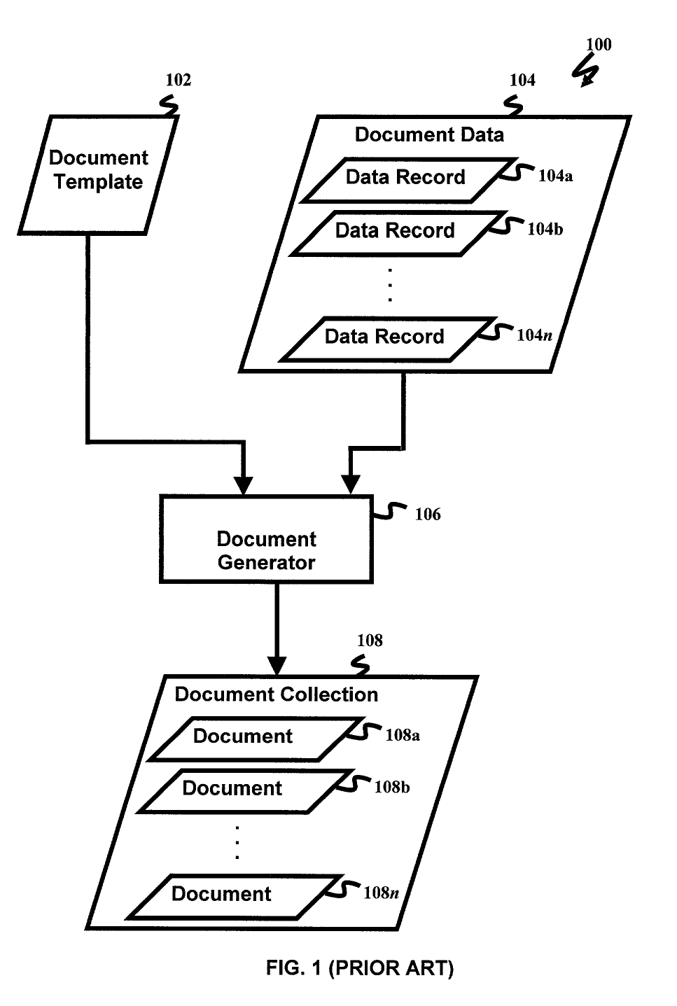

### DETAILED DESCRIPTION

In one aspect, the present invention enables a user to modify the fixed information specified by a document template in a document assembly system by modifying a document generated by the document assembly system. For example, the user may modify fixed information in a document generated from document templates, and thereby cause the document templates to specify the modified fixed information. Subsequent documents generated from the document templates will include the modified information. Modifications to a document template may be stored in the same document template or in another document template. Priorities may be assigned to document templates and to modifications to document templates, and such priorities may enable certain information specified by the document templates to override other information specified by the document templates. These and other features of various embodiments of the present invention advantageously provide the user of the document assembly system with a finer degree of control over document template customization and simplify the process of document assembly.

In another aspect, a computer-implemented method is provided in a system including a document collection, document templates specifying fixed information in the document collection, document data specifying variable information in the document collection, an information integration specification specifying a process for integrating the fixed information and the variable information, and a document generator to generate the document collection based on the document templates, the document data, and the information integration specification. The method receives input indicating modifications to fixed information in at least one of the documents in the document collection, and modifies the document templates to specify the modified fixed information in response to the input. Fixed information in the at least one of the documents may be modified to reflect the modifications indicated by the input. A second document collection may be generated that includes the variable information and the modified fixed information.

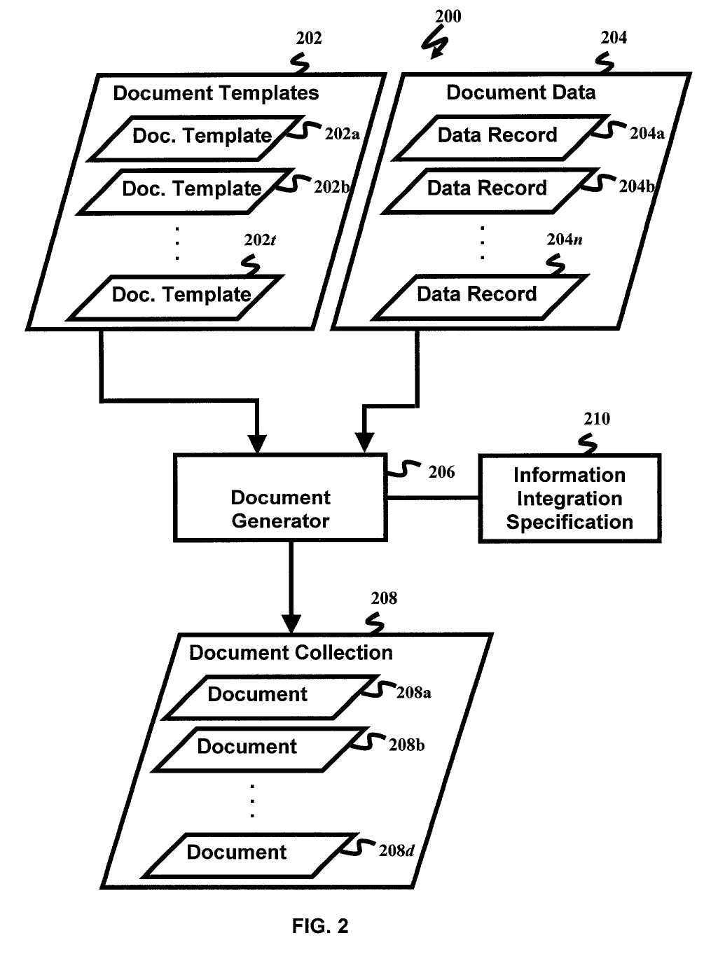

Referring to FIG. 2, in one embodiment a document assembly system 200 includes document templates 202, document data 204, an information integration specification 210, a document generator 206, and a document collection 208. The document collection 208 includes one or more documents 208a-d, where d is the number of documents. The document templates 202 specify fixed information to be included in all of the documents 208a-d. The document templates 202 include one or more document templates 202a-t, where t is the number of document templates. The document data 204 specifies variable information that may differ from document to document. The document data 204 includes one or more data records 204a-n, where n is the number of data records. The information integration specification 210 specifies how the fixed information specified by the document templates 202 is to be integrated with the variable information specified by the document data 204 to generate the document collection 208. The document generator 206 integrates the fixed information specified by the document templates 202 with the variable information specified by the document data 204 according to the information integration specification 210 to generate the document collection 208. Each of the documents 208a-d in the document collection 208 therefore contains all of the fixed information specified by one or more of the document templates 202a-t and at least some of the variable information specified by the data records 204a-n.

Before describing the document assembly system 200 of FIG. 2 in more detail, some terms will be defined. “Information” as used herein means any information that can be represented by a digital computer. For example, information includes any content that may be contained in a digital document, such as text, graphics, sound, video, and any combinations thereof. Information also includes attributes of content that may be represented in a digital document, such as font, font style (e.g., bold, underlined, italics, superscript, and subscript), color, size, relative or absolute position of the content within the document, and chronological sequence. For example, information may be a particular text string (e.g., “To Whom It May Concern”), a text string with associated formatting (e.g., bold, italics, or underlining), or a text string with a particular relative or absolute position in a document. Information may be represented in any computer-readable format, including both proprietary formats such as Rich Text Format (RTF) and Portable Document Format(PDF) and non-proprietary formats such as Hypertext Markup Language (HTML) and Extensible Markup Language (XML). “Information unit” means any collection of information. For example, an information unit may be a character of text, a text string, a graphic, an audio file, or any combination thereof. Information may be arranged in an information unit in any manner. For example, information within an information unit may be contiguous or non-contiguous. Furthermore, information in an information unit may, for example, be arranged in a linear sequence or hierarchically. Information units may contain other information units. An information unit is itself information, as the term “information” is defined herein. “Information specifier” means information that specifies other information (the “specified information”). An “information generator” is a computer-implementable process that generates the specified information specified by an information specifier. An information specifier may specify the specified information in any manner. For example, an information specifier may specify information by reference or by value. References and other links (e.g., references in the information integration specification 210 to the document templates 202 and/or the document data 204) may be implemented in any manner, such as by using pointers in a language such as C or C++, using object references in an object-oriented language such as Java, or using hypertext links in a document markup language such as HTML or XML.

An information specifier may be an expression in a computer programming language that specifies the value of the expression when evaluated in the language. For example, in the C programming language, the expression “strcat(“A”, “B”)” may be considered to be an information specifier that specifies the string “AB” (the concatenation of the strings “A” and “B”), and the C runtime library may be considered to be an information generator that generates the specified information from the information specifier. Similarly, in a conventional mail merge, a particular text string in a form document may be considered to be an information specifier that specifies the text string in merged documents generated from the form document, and the mail merger may be considered to be an information generator that generates the specified information from the information specifier (by copying the text from the form documents to the merged documents). The information specified by an information specifier may be, but need not be, a constant (such as a particular text string). For example, an information specifier may be a function that specifies the current date and time, in which case the specified information may vary depending upon the date and time at which the specified information is generated by the information generator.

“Variable information specifier” means an information specifier to be applied by the document generator 206 to fewer than all of the documents in the document collection 208. Variable information specifiers specify information that may vary among the documents 208a-d in the document collection 208. For example, a field (e.g., recipient's address) in a data document used by a conventional mail merger may be considered to be a variable information specifier because the recipient's address may vary from document to document in the document collection. A “fixed information specifier” is an information specifier to be applied by the document generator 206 to all of the documents 208a-d in the document collection 208. “Fixed information” means information specified by a fixed information specifier. “Variable information” means information specified by a variable information specifier. “Fixed information unit” means an information unit specified by a fixed information specifier. “Variable information unit” means an information unit specified by a variable information specifier.

Fixed information may be, but need not be, a constant value, so long as the fixed information is independent of (i.e., not a function of) variable information specified by the document data 204. For example, fixed information may be a function (such as a function for computing the current system time in milliseconds) that is evaluated at document generation time by the document generator 206, and whose generated value may therefore differ among the documents 208.

Once the document generator 206 has integrated fixed information with variable information to generate the document collection 208, fixed information in the document collection may be modified. For example, a user may edit fixed information in one of the documents 208a-d using a word processor. It should be appreciated, therefore, that fixed information need not “fixed” in the sense that it may not be modified within the documents 208a-d. Rather, fixed information may either remain fixed or be modifiable within the documents 208a-d.

Fixed information may include attributes to be applied to variable information. For example, fixed information may include HTML <b> and </b> tags specifying that any text placed between the tags is to be rendered in boldface. Although the tags are fixed information, variable information in the form of text may be integrated with the tags (by placing the variable information between the tags in one of the documents 208a-d) to apply the attribute (boldface) specified by the tags to the variable information. The use of HTML tags is provided merely for purposes of example and does not constitute a limitation of the present invention. Rather, fixed information may be implemented in any manner to include attributes to be applied to variable information.

Returning to FIG. 2, the document templates 202a-t are examples of fixed information specifiers, the data records 204a-n are examples of variable information specifiers, the information integration specification 210 is an example of an information specifier, the document generator 206 is an example of an information generator, and the document collection 208 and the documents 208a-d within it are examples of information.

The document templates 202, the document data 204, the information integration specification, 210, and the document collection 208 may be represented and tangibly embodied in any manner. For example, in one embodiment each of the document templates 202a-t is implemented in a common document format, such as Extensible Markup Language (XML). In this embodiment, the fixed information specified by each of the document templates 202a-t is the XML text specified by the document template. It should be appreciated that XML is provided merely for purposes of illustration and that fixed information specifiers in any format may be used to specify fixed information. Furthermore, the document templates 202a-t need not share a common document format; rather, some or all of the document templates 202a-t may use different document formats or other schemes to specify fixed information.

The data records 204a-n specify variable information to be integrated with fixed information specified by the document templates 202a-t. Variable information may include any information that may be included in the documents 208. For example, variable information may include content or content attributes, as described above with respect to fixed information. In one embodiment, each of the data records 204a-n specifies variable information for a corresponding one of the documents 108a-n. For example, in one embodiment, the document data 204 is a data document for use in a mail merge system and the data records 204a-n are records in the data document.

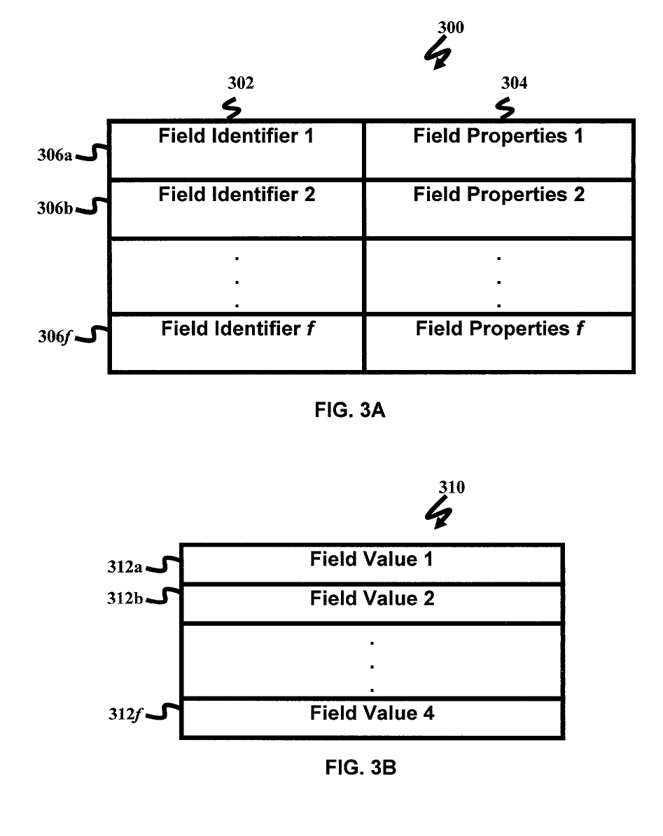

Referring to FIG. 3A, in one embodiment each of the data records 204a-n is defined by a record definition 300. The record definition 300 includes field definitions 306a-f, where f is the number of fields in the record definition 300. The field definitions 306a-f includes field identifiers (field IDs) 302 that uniquely identify each of the field definitions 306a-f within the scope of the record definition 300. The field definitions 306a-f also include field properties 304 that specify properties of the fields defined by the field definitions 306a-f. Field properties may include, for example, data type (e.g., integer, floating point, character string, or date), appearance, validation functions used to validate field values (see FIG. 3B, below), and/or calculation functions used to calculate field values (see FIG. 3B, below). It should be appreciated that the record definition 300 shown in FIG. 3A is provided merely for purposes of illustration and that data records 304a-n may be defined or represented in any manner. For example, data records 304a-n may or may not share a common record definition, and data records 304a-n may contain data that does not conform to any record definition.

Referring to FIG. 3B, in one embodiment each of the data records 204a-n is represented by a record data structure 310. The record data structure 310 includes field values 312a-f, where f is the number of fields in the record data structure 310. Each of the field values 312a-f corresponds to the value of a particular one of the fields of the record represented by the record data structure 310. The field values 312a-f may, for example, each correspond to a distinct one of the fields defined by the field definitions 306a-f (FIG. 3A). For example, the field value 312a may correspond to the field defined by the field definition 306a and the field value 312f may correspond to the field defined by the field definition 306f. It should be appreciated that the record data structure 310 shown in FIG. 3B is provided merely for purposes of illustration and that the data records 204a-n may be implemented in any manner.

The information integration specification 210 specifies how variable information specified by the document data 204 is to be integrated with fixed information specified by the document templates 202 to generate the documents 208. The information integration specification 210 is not limited to any particular implementation or to specifying any particular kind of information integration. The information integration specification 210 may, for example, specify that particular variable information, such as one of the field values 312a-f of one of the data records 204a-n, be inserted at a specified absolute or relative location within the corresponding one of the documents 208a-d when the documents 208a-d are generated by the document generator 206.

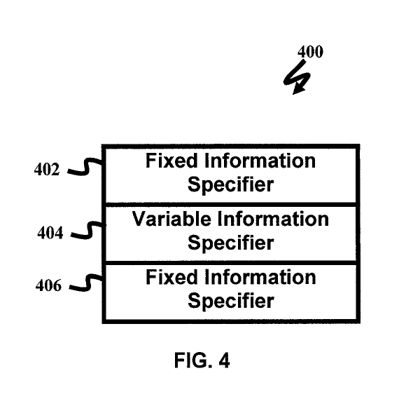

Referring to FIG. 4, in one embodiment, an information integration data structure 400 specifies how fixed information and variable information are to be integrated into a document by the document generator 206. Information integration data structure 400 includes an ordered sequence of information specifiers 402, 404, and 406, which specify information to be included in each of the documents 208 in the specified sequence. Fixed information specifier 402 specifies fixed information, such as plain text, formatted text, text formatting attributes, or graphics, that is to be placed by the document generator 206 at the beginning of the document being generated. Variable information specifier 404 specifies variable information that is to follow the fixed information 402 in the document being generated. The variable information specifier 404 may, for example, be one of the field identifiers 302 (FIG. 3A). The fixed information specifier 406 specifies fixed information that is to follow the variable information specified by the variable information specifier 404 in the document being generated. When the document generator 206 generates a document based on the information integration data structure 400, the document generator 206 generates a document containing the fixed information specified by the fixed information specifier 402, followed by the variable information specified by the variable information specifier 404, followed by the fixed information specified by the fixed information specifier 406.

It should be appreciated that the data structure 400 shown in FIG. 4 is provided merely for purposes of illustration and does not constitute a limitation of the present invention. Rather, as described in more detail below, the information integration specification 210 may be implemented in any manner to specify how to integrate variable information with fixed information. For example, the information integration specification 210 need not specify variable information using the field identifiers 302 (FIG. 3A) and need not specify the relationship of fixed information to variable information in a linear sequence such as that employed by the information integration data structure 400.

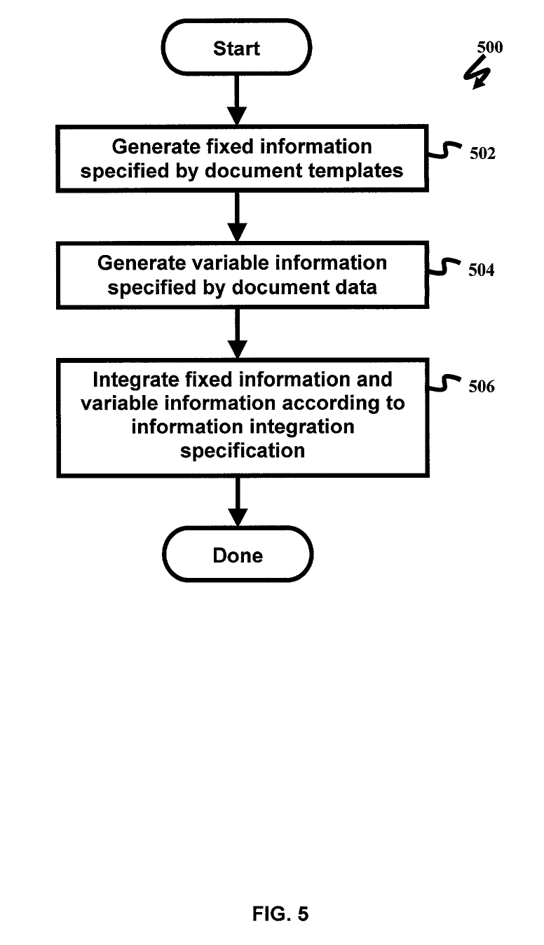

Referring to FIG. 5, in one embodiment the document generator 206 uses a method 500 to generate the documents 208 based on the document templates 202, the document data 204, and the information integration specification 210. The document generator 206 generates fixed information specified by the document templates 202 (step 502). The document generator 206 generates variable information specified by the document data 204 (step 504). The document generator 206 integrates the fixed information and the variable information according to the information integration specification 210 to generate the documents 208 (step 506). It should be appreciated that the steps shown in FIG. 5 need not be performed in the order shown.

The fixed information in the documents 208 may be represented in a manner that identifies the fixed information as fixed information rather than variable information. Similarly, the variable information in the documents 208 may be represented in a manner that identifies the variable information as variable information rather than fixed information. Such representation and identification may be accomplished in any manner. For example, the fixed information in the documents 208 may be delimited with special tags (e.g., XML tags) identifying the fixed information as fixed information, and the variable information in the documents 208 may be delimited with special tags (e.g., XML tags) identifying the variable information as variable information. Use of such tags or other form of representation may be used, for example, to subsequently determine whether particular information within the documents 208 is fixed information or variable information, as described in more detail below. It should be appreciated, however, that fixed information need not be distinguished from or otherwise represented differently than variable information within the documents 208a-d.

In one embodiment, multiple versions of an information unit may be specified by information specifiers. For example, the document templates 202 may specify multiple versions of each one or more fixed information units, and the document data 204 may specify multiple versions of each of one or more variable information units. For example, if the document templates 202 specify fixed information for a business correspondence, the document templates 202 may specify one version of a fixed information unit corresponding to the salutation reading “To Whom It May Concern:” and also specify another version of the same fixed information unit reading “Dear Valued Customer:”. For another example, if the document templates 202 specify style sheets to be applied to the document data 204, the document templates 202 may specify one version of a fixed information unit in which the first line of a document appears in boldface and specify another version of the same fixed information unit in which the first line appears in italics. Different versions of the same information unit may specify any information, except that no version of a fixed information unit may be dependent on (i.e., be a function of) variable information specified by the document data 204.

Different information units may be specified (e.g., in the document templates 202 and the document data 204) and identified (e.g., in the document collection 208) as different information units in any manner. For example, each information unit may be assigned a unique information unit identifier that uniquely identifies the information unit among all information units. Different versions of the same information unit may be specified and identified as different versions of the same information unit in any manner. For example, different versions of the same information unit may share the same unique information unit identifier, while being specified and identified as different versions of the same information unit by each having an information unit version identifier that is unique within the scope of the information unit.

Information unit specifiers, including information unit specifiers specifying different versions of the same information units, may be distributed among the document templates 202 in any manner. For example, in one embodiment, each of the document templates 202 specifies no more than one version of each of the information units specified by the document templates 202. Different versions of the same information unit may, however, be specified by a single one of the document templates 202. Each of the document templates 202 may specify any number of information units.

In one embodiment, fixed information units are associated with information unit priorities. Information unit priorities may be ordered such that for any two information unit priorities p₁ and p₂, either: (1) p₁<p₂, (2) p₁>p₂, or (3) p₁=p₂. For purposes of example, information unit priority p₁ is said to be “higher” than information unit priority p₂ if p₁>p₂, and information unit priority p₁ is said to be “lower” than information unit priority p₂ if p₁<p₂. The priority of a fixed information unit u is referred to as p(u). Fixed information units may be assigned information unit priorities in any manner, and priorities may be distributed among information units and versions of information units in any manner.

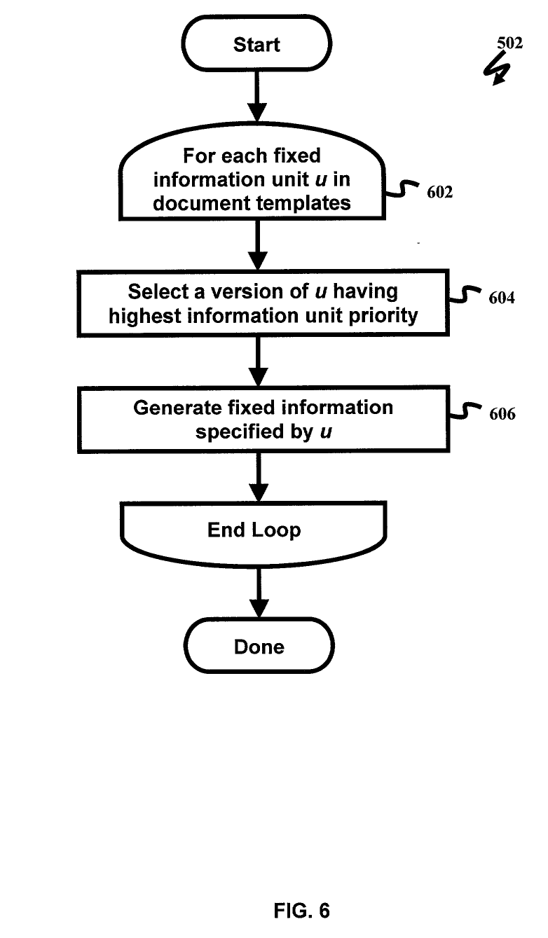

Referring to FIG. 6, in one embodiment, the document generator 206 generates fixed information specified by the document templates (step 502) as follows. The document generator 206 initiates a loop over each fixed information unit u specified by the document templates 202 (step 602). The document generator 206 selects a version of the fixed information unit u having the highest priority among all versions of the information unit u specified by the document templates (step 604). If more than one version of the fixed information unit u shares the highest priority, any version of the fixed information unit u having the highest priority may be selected. The document generator 206 generates the fixed information specified by the fixed information unit u (step 606).

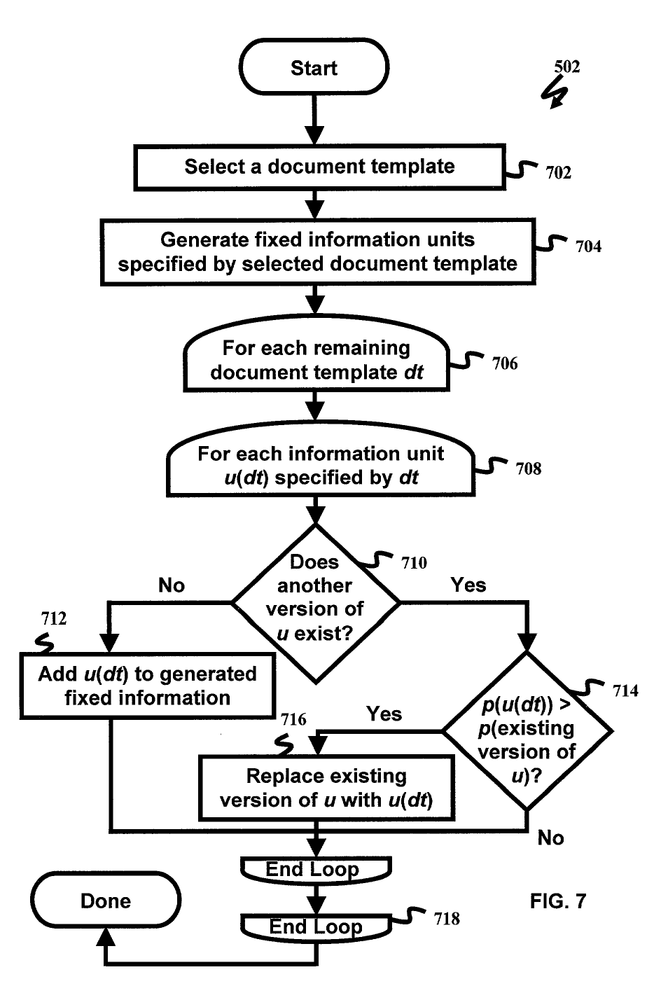

Consider for purposes of example an embodiment in which each of the document templates 202 specifies at most one version of each of the fixed information units specified by the document templates 202. The version of a fixed information unit u specified by a document template dt will be referred to as u(dt). Referring to FIG. 7, in one embodiment the document generator 206 generates fixed information specified by the document templates 202 (step 502) as follows. The document generator 206 selects one of the document templates 202a-t (step 702). The document generator 206 may select any one of the document templates 202a-t in any manner. The document generator 206 generates the fixed information units specified by the document template selected in step 702 (step 704). The fixed information generated in step 704 is referred to as the generated fixed information. The generated fixed information may, for example, be stored in a database or other data structure (not shown) on any computer-readable medium for use by other steps of the process shown in FIG. 7.

The document generator 206 initiates a loop over each remaining document template dt (i.e., the document templates 202a-t other than the document template selected in step 702) (step 706). The document generator 206 initiates a loop over each information unit u(dt) specified by the document template dt (step 708). The document generator 206 determines whether another version of the fixed information unit u exists within the generated fixed information (step 710). If another version of u does not exist within the generated fixed information, the document generator adds u(dt) to the generated fixed information (step 712). If another version of u exists within the generated fixed information, the document generator 206 determines whether the priority of u(dt) is higher than the priority of the version of u currently stored in the generated fixed information by comparing the priorities of the two versions (step 714). If the priority of u(dt) is higher than the priority of the existing version of u, then the document generator 206 replaces the existing version of u with u(dt) in the generated fixed information (step 716). After the loops initiated in steps 706 and 708 have terminated (step 718), the generated fixed information contains the versions of the fixed information units specified by the document templates 202 having the highest priorities.

In another embodiment, each of the document templates 202 specifies at most one version of each of the fixed information units specified by the document templates 202, and each of the document templates 202 has a document template priority. The document template priority of a document template dt is represented as p(dt). In this embodiment, if p(dtₐ)>p(dtb) for document templates dta and dtb, then p(u (dta))>p(u(dtb)) for all fixed information units u that are specified by both dta and dtb. Furthermore, in this embodiment, each of the document templates has a distinct document template priority such that there exists no pair of document templates dtₐ and dt_{b} for which p(dtₐ)=p(dt_{b}).

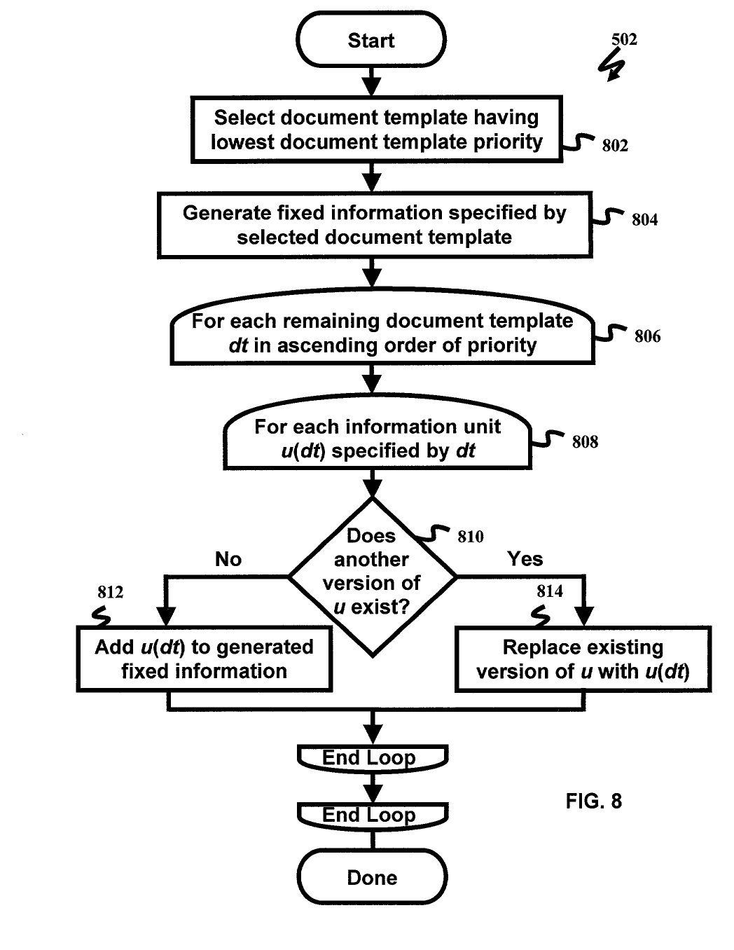

Referring to FIG. 8, in the embodiment just described, the document generator 206 generates the fixed information specified by the document templates 202 (step 502) as follows. The document generator 206 selects the document template having the lowest document template priority among the document templates 202 (step 802), and generates the fixed information specified by the selected document template (step 804) to produce generated fixed information. The document generator 206 initiates a loop over each of the remaining document templates dt (i.e., the document templates other than the document template selected in step 802) in ascending order of document template priority (i.e., from lowest to highest priority) (step 806). The document generator 206 initiates a loop over each fixed information unit u(dt) within the document template dt (step 808+; ). If another 22 version of u does not exist within the generated fixed information (step 810), the document generator adds u(dt) to the generated fixed information (step 812). If another version of u exists within the generated fixed information, the document generator 206 replaces the existing version of the information unit u with u(dt) in the generated fixed information (step 814). After the loops initiated in steps 806 and 808 have terminated (step 816), the generated fixed information contains the versions of the fixed information units specified by the document templates 202 having the highest priorities.

Although in the examples described above with respect to FIGS. 7 and 8, the version of a particular fixed information unit u having the highest priority is used instead of all versions of fixed information u having lower priorities, this is not a limitation of the present invention. Rather, two or more versions of a particular fixed information unit u may be combined in various ways in the order indicated by their relative priorities. For example, referring again to FIG. 7, instead of replacing a lower-priority version of fixed information unit u with a higher-priority version of fixed information unit u at step 716, the higher-priority version of fixed information unit u (i.e., u(dt)) may be combined with the existing version of fixed information unit u in the generated fixed information. For example, if the existing version of fixed information unit u specifies a text string, and higher-priority fixed information unit u(dt) specifies a property such as a particular font, the property (e.g., font) specified by fixed information unit u(dt) may be applied to fixed information unit u at step 716 and the result may be stored in the generated fixed information. (A similar step may be performed in place of step 814 in FIG. 8.) In this way, different versions of the same fixed information unit may be combined in the order specified by their relative priorities to generate fixed information in the document collection 208.

In one embodiment, the user may cause the fixed information specified by the document templates 202 to be modified by modifying one or more of the documents 208. For example, in one embodiment the user may modify a fixed information unit in one of the documents 208, in response to which the document templates 202 may be modified to specify the modified fixed information unit rather than the original, unmodified information unit. In another embodiment, the user may modify a variable information unit in one of the documents 208, in response to which the document templates 202 may be modified to specify the modified variable information unit. In yet another embodiment, the user may add a fixed information unit to one of the documents 208, in response to which the document templates 208 may be modified to specify the added fixed information unit. Modification by the user of the fixed information specified by the document templates 208 is described in more detail below.

One advantage of certain embodiments of the present invention is that they enable users to strike a personalized balance between the uniformity made possible by use of document templates and the customization that may be necessary or desirable for particular document generation tasks. Although conventional document assembly systems may reduce the amount of time and effort needed to generate large numbers of documents by automatically generating fixed information, such fixed information may not be appropriate for all documents or all users. It may be desirable, therefore, to modify documents generated by conventional document assembly systems to suit the needs of a particular task or user. In some situations it may be desirable to make the same or similar changes to a large number of documents in a document collection. For example, it may be desirable to change the font size of all documents in a document collection to a different size than that specified by a document template. In such a situation, certain embodiments of the present invention may be used to automate such changes to all or some of the documents in a document collection. Such automation may be achieved without modifying the original document template. This provides the user with the ability to automate document generation with a finer degree of control than typically is possible with conventional document assembly systems.

Furthermore, in conventional document assembly systems a single document template is typically used to generate all documents of a particular type. For example, a single “business letter” template may be used to generate business letters. Such a template is typically used by users of the document assembly system to generate all business letters. If the single document template is not appropriate for the needs of a particular user or a particular document generation task, the single document template may be modified to suit the user or task and then used to generate documents. Such an approach, however, results in the unavailability of the original (unmodified) version of the document template, which may still generally be useful for many users or tasks. Furthermore, in some circumstances, the user may not have direct access to the original document template or have authorization or access privileges to modify the original document template, making this approach untenable.

Alternatively, the user may modify (and perhaps locally store) a copy of the single document template, and use the modified copy to generate documents. Such an approach, however, results in the proliferation of multiple versions of the single document template, decreasing the usefulness of the document template as a tool for ensuring uniformity of document content. Furthermore, the user's modified copy of the document template will typically not be affected by subsequent modifications to the original document template, therefore reducing the ability of the system administrator to enforce uniformity of document content through the maintenance of a repository of document templates.

In a conventional document assembly system, the user may choose to modify neither the original document template nor a copy of the original document template and instead directly modify the documents generated using the original document template. This approach, however, may result in the user inefficiently making the same modifications to several or all of the documents generated using the original document template.

Certain embodiments of the present invention may be advantageously used to automate customization of documents generated by a document assembly system without requiring modification to an original document template. For example, as described above, modified fixed information specified by the user may be stored in a separate document template having a higher document template priority than the original document template. The modified fixed information may be used to effectively override corresponding fixed information specified by the original document template. Using this approach, the document generator 206 may be used to generate documents containing: (1) the fixed information specified by the original document template in addition to the modified fixed information, and/or (2) the fixed information specified by the original document template except for certain fixed information that is replaced by the modified fixed information.

Using embodiments of the present invention, system administrators, whose task is to create and maintain generally applicable system tools, may create generally applicable document templates. Users, who are best able to determine their own needs in particular situations, may create document template customizations without affecting the generally applicable document templates. This may enable a division of labor that may be advantageous for a variety of organizations. Customizations may also effect groups of users at any level of granularity that is appropriate for a particular organization.

Furthermore, in certain embodiments users may advantageously decide which document template customizations to use when generating a particular document collection. This enables users to create document customizations that are applied to certain kinds of document collections and not to others. Furthermore, users may assemble particular customizations into groups, thereby enabling users to mix and match customizations to fit the exigencies of a particular document generation task. For example, a user may combine font customizations from one document template and audio customizations from another document template to generate a particular document collection.

In certain embodiments, document templates may be represented and tangibly embodied in an advantageously efficient manner. For example, consider a conventional mail merge system in which the user desires two document templates that differ only in a minor feature, such as the document's font. In such a system the user must typically create two document templates each containing the entire document text but differing in the font used. Certain embodiments of the present invention may be advantageously used to reduce the amount of storage space needed to store multiple document templates such as those just described. For example, in the example just described, in one embodiment a first document template may specify the document's text using a first font, and a second document template having a higher document template priority than the first document template may specify a second font (without specifying the text specified by the first document template). The first document template may be used to generate text in the first font and a combination of the first and second document templates may be used to generate text in the second font. In other words, the second document template specifies only the differences between the fixed information specified by the first document template and the fixed information specified by the second document template, thereby resulting in more efficient storage of document templates.

In certain embodiments, the present invention advantageously provides a straightforward and intuitive interface for customizing document templates. In particular, the user may interactively modify a document template by editing a document generated using the document template. To modify a document template in a conventional document assembly system the user typically edits the document template directly. Many users are not familiar with the commands and codes required to modify document templates, and direct modification of document templates interrupts the user's main task of authoring and editing documents. By enabling the user to effect customizations to a document template by interactively editing a document generated using the document template, the user may customize the document template without interrupting the primary task of document authoring and without requiring specialized knowledge of document templates. Furthermore, when editing the document the user may view document template customizations directly and immediately without having to use the document generator 206 to re-generate the document.

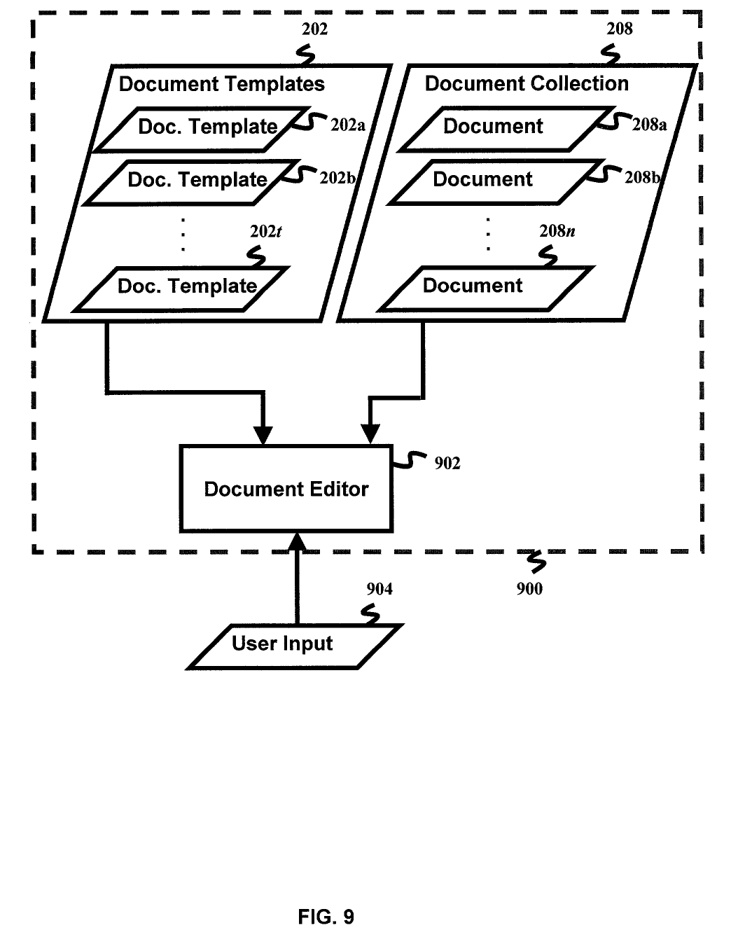

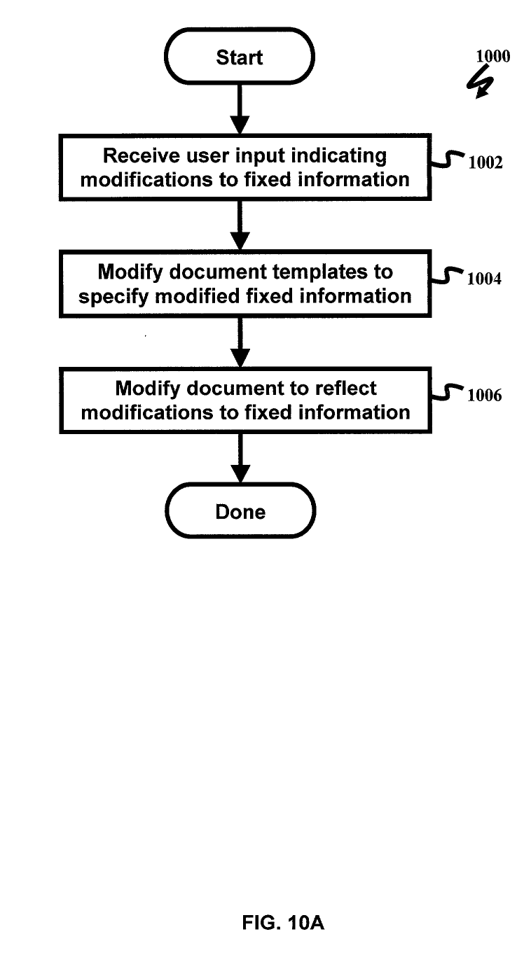

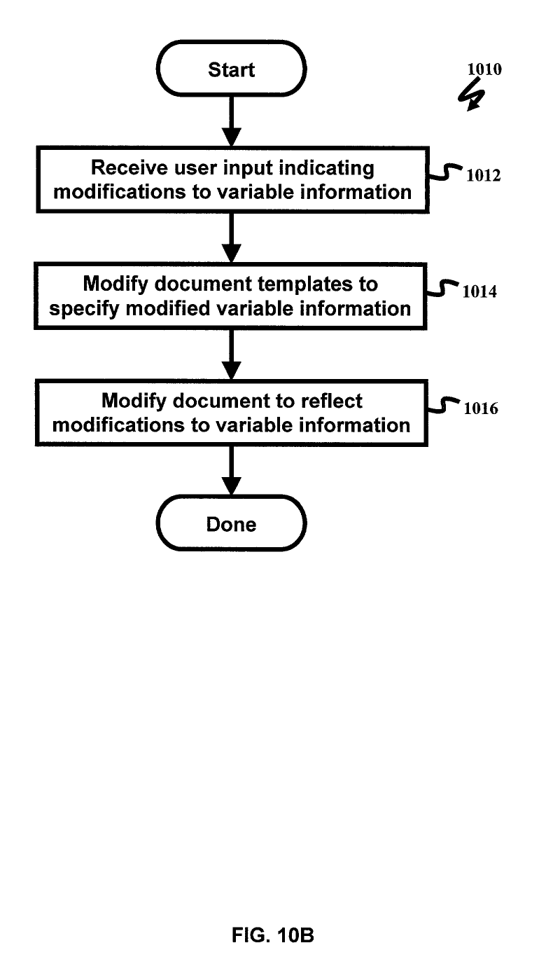

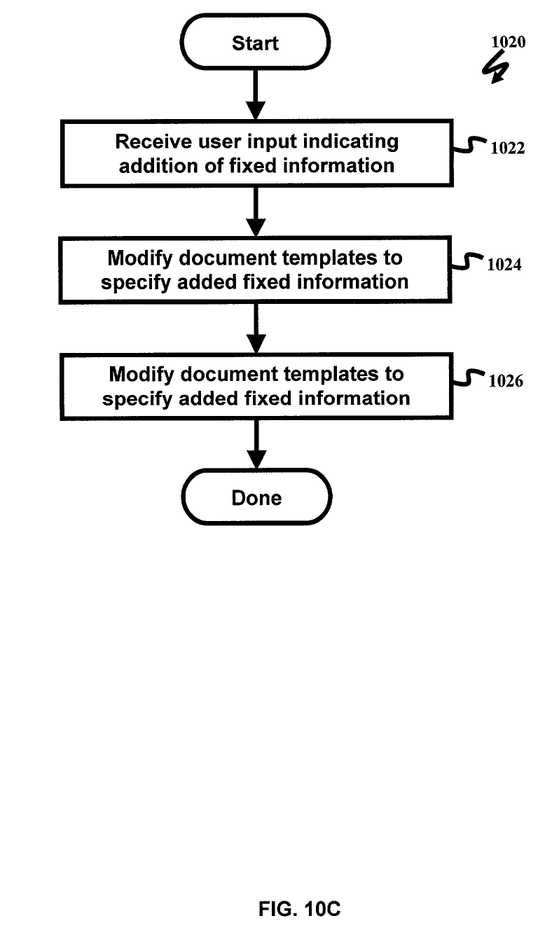

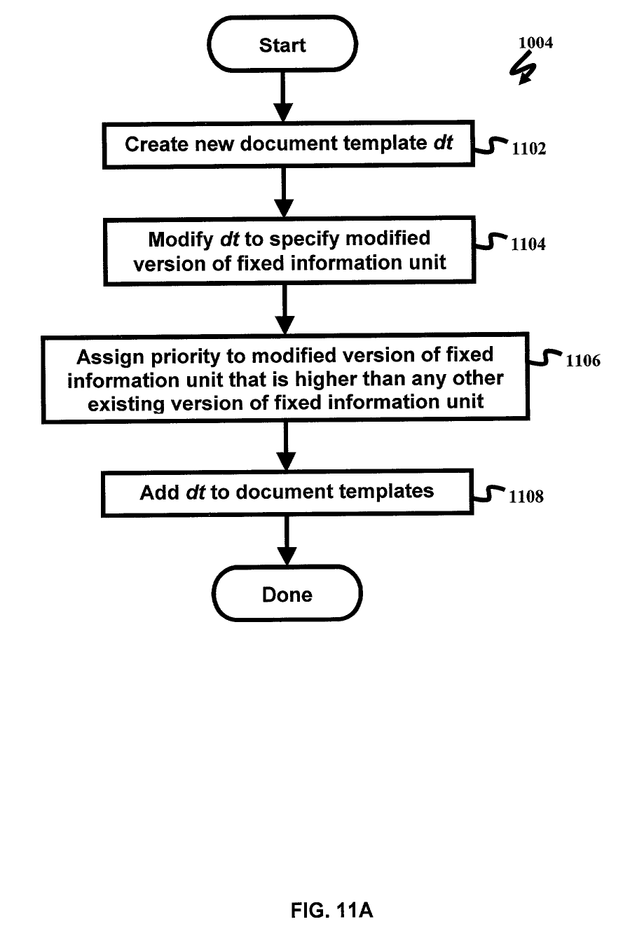

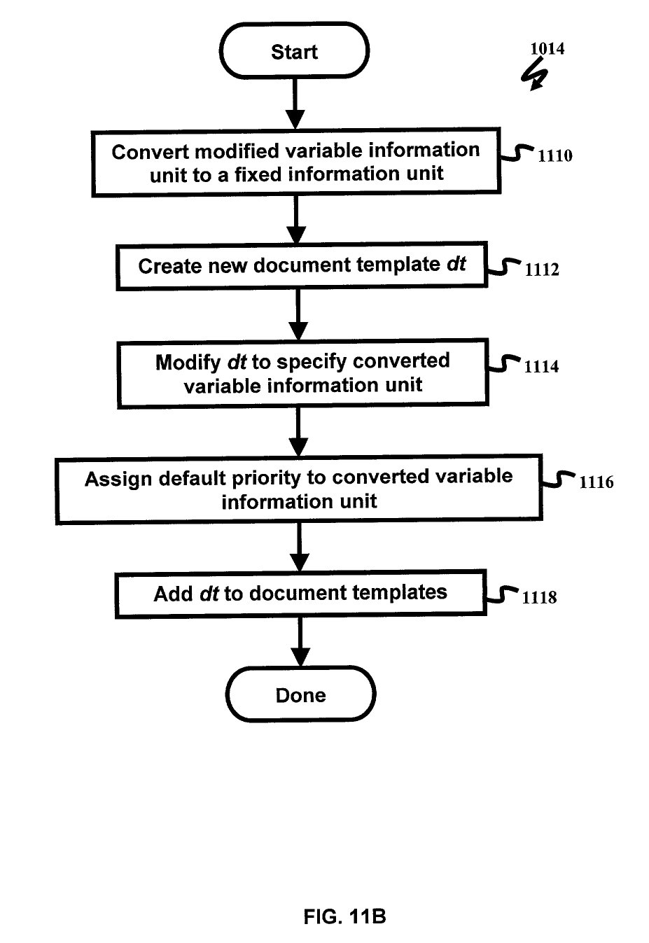

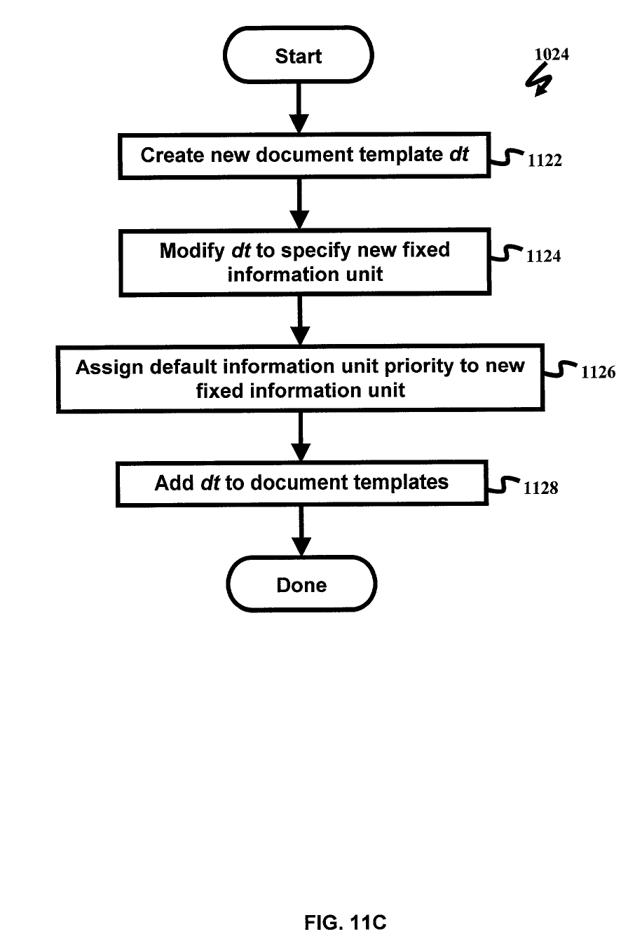

In other embodiments, the present invention may be advantageously used to facilitate the process of developing a single document or a collection of documents having shared characteristics. For example, consider a situation in which a user desires to generate a collection of documents having common information that differs from fixed information specified by the document templates 202. In particular, consider an example in which the user uses a web page (HTML) template to generate a single web page. The user modifies the web page by changing an attribute such as the background color. A document editor (an example of which is described in more detail below with respect to FIG. 9) may modify the document templates 202 to specify the changed background color (as described below with respect to FIGS. 10A and 11A). The user may then use the document generator 206 to generate a collection of web pages having the changed background color using the modified document templates.

Similarly, in another embodiment, the present invention may be advantageously used to facilitate the development of a single document. Fox example, the user may generate a document from a document template and modify or add a fixed or variable information unit in the document. As described below with respect to FIGS. 10A-C and FIGS. 11A-C, in various embodiments of the present invention these modifications or additions are reflected in the document templates 202. The user may desire to regenerate the document at a subsequent time without having to manually re-enter the previous modifications. For example, if one or more of the data records 204a-n changes, the user may wish to regenerate the document to reflect the changes in the data records 204a-n. The user may accomplish this goal in one embodiment of the present invention by using the document generator 206 to regenerate the document. Because the document templates 202 specify the modifications to the fixed information previously made by the user, the regenerated document includes the modifications, making it unnecessary for the user to manually re-enter the modifications to the fixed information.

Referring to FIG. 9, in one embodiment, the user may use a document editing system 900 to modify the fixed information specified by the document templates 202. The document editing system 900 includes the documents 208, the document templates 202, and a document editor 902. The document editor 902 receives user input 904 and modifies the documents 208 based on the user input 904. The document editor 902 may, for example, be a word processor that provides the user with the ability to modify the documents 208 using document editing commands.

The user may cause the fixed information specified by the document templates 202 to be modified in any of a variety of ways. For example, referring to FIG. 10A, in one embodiment the document editor 902 may modify the fixed information specified by the document templates 202 using a process 1000. The document editor 902 receives user input 904 indicating modifications to a fixed information unit in one of the documents 208 (step 1002). As described above, information units within the documents 208 may be represented and identified as fixed information units in any of a variety of ways, so that they document editor 902 may determine whether the user input indicates modifications to a fixed information unit.

In response to the modification of the fixed information unit by the user, the document editor 902 modifies the document templates 202 to specify the modified fixed information unit (step 1004). The document editor 902 also modifies the document to reflect the indicated changes to the fixed information unit (step 1006). For example, in one embodiment, the document editor 902 modifies the document and presents the modified document to the user. The document editor 902 may, for example, present the user with a word processor-like interface in which the user may edit the document. As the user edits a fixed information unit in the document, the document editor 902 may display the effects of the user's edits (as in a standard word processor) and also modify the document templates 202 to specify the modified fixed information unit.

The document editor 902 may modify the document templates 202 in step 1004 in any of a variety of ways. For example, referring to FIG. 11A, in one embodiment the document editor 902 creates a new document template dt (step 1102) and modifies the document template dt to specify the modified version of the fixed information unit (step 1104). As an alternative to steps 1102 and 1104 the document editor 902 may, for example, add an information specifier specifying the modified version of the fixed information unit to an existing one of the document templates 202 (in which case step 1108, described below, is not performed). The document editor 902 may, for example, identify one of the document templates 202 that was previously used to generate the document currently being edited by the user, and add an information specifier specifying the modified version of the fixed information unit to the identified document template.

If one of the document templates 202 already contains a fixed information unit specifier that specifies the fixed information unit modified by the user, the document editor 902 may either: (1) replace the existing fixed information unit in the document template with a fixed information unit specifier that specifies the modified version of the fixed information unit; or (2) modify the existing fixed information unit specifier to specify the modified fixed information unit. For example, the document editor 902 may identify one of the document templates 202 that was previously used to generate the document currently being edited by the user. The document editor 902 may identify, within the identified document template, a fixed information unit specifier that specifies the fixed information unit modified by the user. The document editor 902 may: (1) modify the identified fixed information unit specifier to specify the modified fixed information indicated by the user; or (2) replace the identified fixed information unit specifier with a fixed information unit specifier that specifies the modified fixed information indicated by the user.

The document editor 902 may assign to the modified version of the fixed information unit an information unit priority that is higher than the priority of any other version of the fixed information unit specified by the document templates 202 (step 1106). The document editor 902 may also assign to the document template dt a document template priority that is higher than the priority of any other document template in the document templates 202. The document editor 902 adds the document template dt to the document templates 202 (step 1108). As a result, when the document generator next generates a document using the document templates 202 using a process such as that shown in FIG. 7, the document generator 206 will generate a document containing the modified fixed information unit.

Referring to FIG. 10B, in another embodiment, the document editor 902 modifies the fixed information specified by the document templates 202 using a process 1010 when the user modifies a variable information unit in the documents 208. When the document editor 902 receives user input 904 indicating modifications to a variable information unit in one of the documents 208 (step 1012), the document editor 902 modifies the document templates 202 to specify the modified version of the variable information (step 1014). The document editor 902 also modifies the document to reflect the indicated changes to the variable information unit (step 1016).

The document editor 902 may perform step 1014 in any of a variety of ways. For example, referring to FIG. 11B, in one embodiment the document editor 902 performs step 1014 by converting the modified version of the variable information unit to a fixed information unit (step 1110), creating a new document template dt (step 1112), and modifying the document template dt to specify the fixed information unit created in step 1110 (step 1114). As an alternative to steps 1112 and 1114 the document editor 902 may, for example, modify an existing one of the document templates 202 (such as one of the document templates 202 that was previously used to generate the document being edited by the user) to specify the fixed information unit created in step 1110 (in which case step 1118, described below, is not performed).

The document editor 902 assigns a default unit priority to the modified version of the variable information unit (step 1116). The document editor 902 may also assign a default document template priority to the document template dt. Each of the default information unit and document template priorities may be any priority and may be selected in any manner. In one embodiment, in which each of the document templates 202 has a document template priority, the default information unit priority assigned in step 1116 is the document template priority of the new or existing document template dt. The document editor adds the document template dt to the document templates 202 (step 1118). The document editor 902 may also use the process shown in FIG. 11B in a similar manner to modify the fixed information specified by the document templates 202 when the user adds variable information to the documents 208.

Referring to FIG. 10C, in another embodiment, the document editor 902 modifies the fixed information specified by the document templates 202 using a process 1020 when the user adds a fixed information unit to the documents 208. When the document editor 902 receives user input indicating the addition of a fixed information unit to one of the documents 208 (step 1022), the document editor 902 modifies the document templates 202 to specify the fixed information unit added by the user in step 1022 (step 1024). The document editor 902 also modifies the document to reflect the indicated addition of the fixed information unit (step 1026).

The document editor 902 may perform step 1024 in any of a variety of ways. For example, referring to FIG. 11C, in one embodiment the document editor 902 performs step 1024 by creating a new document template dt (step 1122) and modifying the document template dt to specify the fixed information unit added in step 1022 (step 1124). As an alternative to steps 1122 and 1124 the document editor 902 may, for example, modify an existing one of the document templates 202 (such as one of the document templates that was previously used to generate the document being edited by the user) to specify the fixed information unit created in step 1022 (in which case step 1128, described below, is not performed).

The document editor 902 assigns a default unit priority to the fixed information unit created in step 1022 (step 1126). The document editor 902 may also assign a default document template priority to the document template dt. The default unit or document template priority may be any priority and be selected in any manner, as described above. The document editor adds the document template dt to the document templates 202 (step 1128).

The document editor 902 may provide the user with various degrees of control over the manner and extent to which modifications to the documents 208 cause the document editor 902 to modify the document templates 202. For example, in one embodiment, when the user modifies fixed information (step 1002), modifies variable information (step 1012), or adds fixed information (step 1022) to one of the documents 208, the document editor 902 prompts the user to approve or disapprove of modifications to the document templates 202 (FIGS. 11A-C). In this embodiment, the document editor 902 only modifies the document templates 202 (FIG. 10A, step 1004; FIG. 10B, step 1014; FIG. 10C, step 1024) if the user approves of the modifications. In another embodiment, the user configures the document editor 902 to make only those kinds of changes desired by the user, such as modifications to fixed information, addition of fixed information, modification of variable information, or modifications of certain kinds of information, such as modification of content attributes such as font, font style, color, or relative or absolute position.

The document templates 202 or any subset thereof may be associated with a particular user or with any group of users. When a user associated with a subset of the document templates 202 causes the document generator 206 to generate the documents 208, the document generator 206 may use only those document templates associated with the user (or the user's group if the user is a member of a group) to generate fixed information in the documents in step 502 of FIG. 5. For example, in one embodiment a subset of the document templates 202a-t is associated with a group of users. When a member of the group of users causes the document generator 206 to generate the documents 208, the document generator 206 uses only the subset of the document templates 202a-t to generate fixed information in the documents (FIG. 5, step 502).

Users of the document assembly system 200 may be given control over the use of the document templates 202 to generate fixed information in the documents 208 in any of a variety of ways. For example, in one embodiment, the user may select a subset of the document templates 202 to cause the document generator 206 to use only the selected subset of the document templates 202 to generate fixed information in the documents 208 in step 502 of FIG. 5. The user may select the subset in any of a variety of ways. For example, in one embodiment the user may select a subset of the document templates 202 and assign an identifier to the subset. Upon subsequently initiating execution of the document generator 206, the user may select the subset by specifying the assigned identifier.

It should be appreciated that the document templates 202 may be implemented in any manner. For example, each of the document templates 202a-t may be implemented as a separate digital document. Alternatively, all of the document templates 202a-t may be implemented as a single digital document. The document templates may be tangibly embodied in any computer-readable medium and may contain any kind of information as defined herein. Similarly, the document data 204 may be implemented in any manner. For example, each of the data records 204a-n may be implemented as a separate digital document. Alternatively, all of the data records may be implemented as a single digital document. The data records may be tangibly embodied in any computer-readable medium and may contain any kind of information as defined herein.

As used herein, “document” refers to any computer-readable data structure, including any text file, database, web page, application program, executable file, or any subset or combination thereof in any format. More generally, “document” as used herein refers to any presentation capable of being generated, stored, displayed, processed, or transmitted by a digital computer, such as an image, audio stream, video stream, print job, or multimedia presentation. A document may be stored in a single computer-readable file. Alternatively, multiple documents may be stored in a single file, or a single document may be stored in multiple files. The document collection 208 may be implemented in any manner and may include any number and kind of documents. Furthermore, documents 208a-d may be combined or divided in any manner consistent with the description herein.

There may be a one-to-one mapping between the number n of data records 204a-n and the number d of documents 208a-d. There may, however, be any mapping between the number of data records 204a-n and the number of documents 208a-d. Similarly, there may be any mapping between and among the document templates 202a-t, the documents 208a-n, and the data records 204a-n.

Elements of the document assembly system 200, including the document templates 202, the document data 204, the information integration specification 210, the document generator 206, and the document collection 208, may be combined or divided in any manner to perform the functions described herein. For example, the information integration specification 210 may be merged with one or more of the document templates 202. Furthermore, the document data 204 and the document templates 202 may be merged. As a further example, the information integration specification 210 may be part of the document generator 206.

For example, in one embodiment, a file format similar to that used by conventional mail mergers may be used to implement both the document templates 202 and the information integration specification 210. A single file defined according to such a file format may, for example, specify fixed information units simply by including such fixed information units (e.g., text strings) in the file. The file may also include tags interspersed within the fixed information units. Such tags may specify the location and kind of variable information to be integrated with the fixed information units. Such tags may, for example, be delimited by special characters (such as “<” and “>”). A field name may, for example, be included between the delimiting characters to specify the variable information (e.g., text) to be integrated. The document generator 206 may use such a file to integrate the document data 204 with the document templates 202. It should be appreciated that in the embodiment just described, the information integration specification 210 is not a separate document, but rather is implemented using the file format described, which uses tags to specify which variable information is to be integrated and where such variable information is to be located relative to the fixed information.

It is to be understood that although the invention has been described above in terms of particular embodiments, the foregoing embodiments are provided as illustrative only, and do not limit or define the scope of the invention. Other embodiments are also within the scope of the present invention, which is defined by the scope of the claims below.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Computer programs used to implement embodiments of the present invention may be implemented in any programming language, such as assembly language, machine language, a high-level procedural programming language, or an object-oriented programming language.

Such computer programs may be implemented in a computer program product tangibly embodied in a machine-readable storage device for execution by a computer processor. Method steps of embodiments of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CDROMs. Any of the foregoing may be supplemented by, or incorporated in, specially-designed ASICs (application-specific integrated circuits). A computer can generally also receive programs and data from a storage medium such as an internal disk or a removable disk. These elements will also be found in a conventional desktop or workstation computer as well as other computers suitable for executing computer programs implementing the methods described herein, which may be used in conjunction with any digital print engine or marking engine, display monitor, or other output device capable of producing color or gray scale output on paper, film, display screen, or other output medium.

What is claimed is:

1. A computer-implemented method comprising steps of:
(A) receiving input from a user indicating a modification to a select fixed information unit in at least one document in a document collection generated by a document generator based on at least one document template specifying fixed information in the document collection, document data specifying variable information in the document collection, and an information integration specification specifying a process for integrating the fixed information and the variable information; and
(B) providing, within the at least one document template, a modified fixed information unit specifier that specifies a modified fixed information unit reflecting the indicated modification to the select fixed information unit.

2. The method of claim 1, further comprising a step of:
(C) modifying the select fixed information unit in the at least one document to reflect the modification indicated by the input.

3. The method of claim 1, further comprising a step of:
(C) replacing the select fixed information unit in the at least one document with the modified fixed information unit.

4. The method of claim 1, further comprising a step of:
(B) generating a second document collection including the variable information and the modified fixed information unit.

5. The method of claim 1, wherein the step (B) comprises steps of:
(B)(1) identifying, in the at least one document template, a fixed information unit specifier that specifies the select fixed information unit; and
(B)(2) modifying the identified fixed information unit specifier to specify the modified fixed information unit.

6. The method of claim 1, wherein the step (B) comprises a step of:
(B)(1) adding to the at least one document template a new fixed information unit specifier that specifies the modified fixed information unit.

7. The method of claim 6, wherein the at least one document template includes a plurality of fixed information unit specifiers specifying a plurality of fixed information units, wherein the plurality of fixed information unit specifiers have a plurality of information unit priorities, and wherein the step (B)(1) comprises a step of assigning to the new fixed information unit specifier an information unit priority that is higher than the information unit priority of any of the plurality of fixed information unit specifiers that specify the select fixed information unit.

8. The method of claim 1, wherein the step (A) comprises a step of receiving input indicating modification of fixed information within the select fixed information unit.

9. The method of claim 1, wherein the step (A) comprises a step of receiving input indicating addition of fixed information within the select fixed information unit.

10. The method of claim 1, wherein the step (A) comprises a step of receiving input indicating deletion of fixed information within the select fixed information unit.

11. A computer-implemented method comprising steps of:
(C) receiving input from a user indicating a modification of a select variable information unit in at least one document in a document collection generated by a document generator based on at least one document template specifying fixed information in the document collection, document data specifying variable information in the document collection, and an information integration specification specifying a process for integrating the fixed information and the variable information; and
(D) providing, within the at least one document template, a fixed information unit specifier that specifies the select variable information unit.

12. The method of claim 11, further comprising a step of:
(C) modifying the select variable information unit in the at least one document to reflect the modification indicated by the input.

13. The method of claim 11, further comprising a step of:
(C) replacing the select variable information unit in the at least one of the documents with a modified variable information unit reflecting the modification indicated by the input.

14. The method of claim 11, further comprising a step of:
(C) generating a second document collection including the fixed information and a modified variable information unit reflecting the modification indicated by the input.

15. The method of claim 11, wherein the step (B) comprises a step of:
(B)(1) adding to the at least one document template a new fixed information unit specifier that specifies a modified variable information unit reflecting the modification indicated by the input.

16. The method of claim 15, wherein the at least one document template includes a plurality of fixed information unit specifiers specifying a plurality of fixed information units, wherein the plurality of fixed information unit specifiers have a plurality of information unit priorities, and wherein the step (B)(1) comprises a step of assigning to the new fixed information unit specifier a default information unit priority.

17. The method of claim 11, wherein the step (A) comprises a step of receiving input indicating modification of variable information within the select variable information unit.

18. The method of claim 11, wherein the step (A) comprises a step of receiving input indicating addition of variable information within the select variable information unit.

19. The method of claim 11, wherein the step (A) comprises a step of receiving input indicating deletion of variable information within the select variable information unit.

20. A system comprising:
at least one document template including a plurality of fixed information specifiers, the plurality of fixed information specifiers specifying a plurality of versions of a fixed information unit, each of the plurality of versions of the fixed information unit having a priority;
document data specifying variable information;
an information integration specification specifying a process for integrating the fixed information unit and the variable information; and
document generation means for generating the fixed information unit by performing steps of:
(A) initializing the fixed information unit to an initial value; and
(B) for each of the plurality of fixed information specifiers u, in ascending order of priority, performing steps of:
(1) generating an interim fixed information unit specified by the fixed information specifier u; and
(2) applying the interim fixed information unit to the fixed information unit.

21. The system of claim 20, wherein the document generation means further comprises means for performing a step of:
(C) integrating the fixed information unit with the variable information using the process specified by the information integration specification.

22. The system of claim 20, wherein the step (B)(2) comprises a step of replacing the fixed information unit with the interim fixed information unit.

23. The system of claim 20, wherein the step (B)(2) comprises a step of adding the interim fixed information unit to the fixed information unit.

24. The system of claim 20, wherein the step (B)(2) comprises a step of applying properties specified by the interim fixed information unit to the fixed information unit.

25. A system comprising:
means for receiving input from a user indicating a modification to a select fixed information unit in at least one document in a document collection generated by a document generator based on at least one document template specifying fixed information in the document collection, document data specifying variable information in the document collection, and an information integration specification specifying a process for integrating the fixed information and the variable information; and
means for providing, within the at least one document template, a modified fixed information unit specifier that specifies a modified fixed information unit reflecting the indicated modification to the select fixed information unit.

26. The system of claim 25, further comprising:
means for generating a second document collection including the variable information and the modified fixed information unit.

27. The system of claim 25, wherein the means for providing comprises:
means for identifying, in the at least one document template, a fixed information unit specifier that specifies the select fixed information unit; and
means for modifying the identified fixed information unit specifier to specify the modified fixed information unit.

28. A system comprising:
means receiving input from a user indicating a modification of a select variable information unit in at least one document in a document collection generated by a document generator based on at least one document template specifying fixed information in the document collection, document data specifying variable information in the document collection, and an information integration specification specifying a process for integrating the fixed information and the variable information; and
means for providing, within the at least one document template, a fixed information unit specifier that specifies the select variable information unit.

29. The system of claim 28, further comprising:
means for generating a second document collection including the fixed information and a modified variable information unit reflecting the modification indicated by the input.

30. In a system including:
at least one document template including a plurality of fixed information specifiers, the plurality of fixed information specifiers specifying a plurality of versions of a fixed information unit, each of the plurality of versions of the fixed information unit having a priority;
document data specifying variable information; and
an information integration specification specifying a process for integrating the fixed information unit and the variable information;
a method for generating the fixed information unit, the method comprising steps of:
(A) initializing the fixed information unit to an initial value; and
(B) for each of the plurality of fixed information specifiers u, in ascending order of priority, performing steps of:
(1) generating an interim fixed information unit specified by the fixed information specifier u; and
(2) applying the interim fixed information unit to the fixed information unit.
